(19) United States
(12) Patent Application Publication
(10) Pub. No.: US 2005/0276986 A1
(43) Pub. Date: Dec. 15, 2005

(54) Flame-retardant structure and method for producing

(76) Inventor: Mel Bingenheimer, Norman, OK (US)

Correspondence Address: GIFFORD, KRASS, GROH, SPRINKLE & CITKOWSKI, P.C, PO BOX 7021, TROY, MI, 48007-7021, US

(21) Appl. No.: 10/865,606

(22) Filed: Jun. 10, 2004

(51) Int. Cl. C08G 77/00; B32B 27/00

(52) U.S. Cl. 428/423.1

(57) ABSTRACT

A flame-retardant structure and method of producing exhibiting a specified shape and size and which includes a polyurethane layer, a phenol formaldehyde layer and a water-impervious surface coating. The polyurethane layer incorporates an anorganic metallic stabilant, and such as specifically an ammonium compound. The phenol formaldehyde layer incorporates an inorganic particulate, and such as which includes either or both of a volume of hollowed spheres or a volume of acid etched graphite particulates.

### BACKGROUND OF THE INVENTION

1. Field of the Invention

The present invention relates generally to flame-retardant fabrics and structures. More particularly, the present invention discloses a modified flame-retardant structure and method for producing, the material satisfying existing fire rating requirements.

2. Description of the Prior Art

Various reinforced and non-reinforced polyester and polyethylene based structures are known in the art. These are typically incorporated into foam boards and foam sheets, in particular for replacing wood and metal in various applications.

A particular example of such a structure is known by the trade name ULTRATEX® and includes a base polyurethane layer, phenol formaldehyde layer and an uppermost melamine layer produced according to a desired process incorporating specified terms. A key requirement of such synthetically produced materials is that they satisfy given standards of heat and smoke resistance. Among these are included the Standard Method of Test for Surface Flammability of Materials Using a Radiant Heat Energy Source (ASTM E 162-98), and the Standard Test Method for Specific Optical Density of Smoke Generated by Solid Materials (ASTM E 662-01).

Another example of a fire-resistant structural material and fabric made therefrom is set forth in U.S. Patent Application Publication No. 2003/0228460, and which teaches such as prefabricated microcells, a surfactant-generated microcell component, a surfactant component, a filler component and a binder component. The composition thus defined is coated over a material for which fire-resistant capabilities are important, such particularly including mattresses.

### SUMMARY OF THE PRESENT INVENTION

The present invention discloses a flame-retardant structure and method of producing, and such as which is in particular suited for use as a fire and smoke-resistant panel or flooring. As also previously stated, the modified flame-retardant structure and method for producing satisfies existing fire and smoke rating requirements.

The structure includes a polyurethane material including an anorganic metallic stabiliant, such as in particular an ammonium compound and, more specifically, ammonium-octyl molybdenate. A phenol formaldehyde material incorporates an inorganic particulate and which may be drawn from one or both of a volume of hollow glass spheres and a volume of etched graphite particles. The etched graphite particulates in particular expand by a factor of up to 30× upon being heated at or above a range of 300-600° F., and in order to create an air buffer for the material.

The inorganic particular is further typically applied in a range of 20 to 80 percent, by weight, relative to the volume content of the phenol formaldehyde layer. A heat insulative air buffer is created within the material and typically by the introduction of gas-entrained air pockets at a volume of 50 to 80 percent relative to that of the overall material volume and in order to provide a heat insulative buffer to the material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a structural perspective view of a flame-retardant structure produced according to the present invention; and

FIG. 2 is a schematic illustrating the method steps associated with producing the flame-retardant structure.

### DETAILED DESCRIPTION OF THE PREFERRED EMBODIMENTS

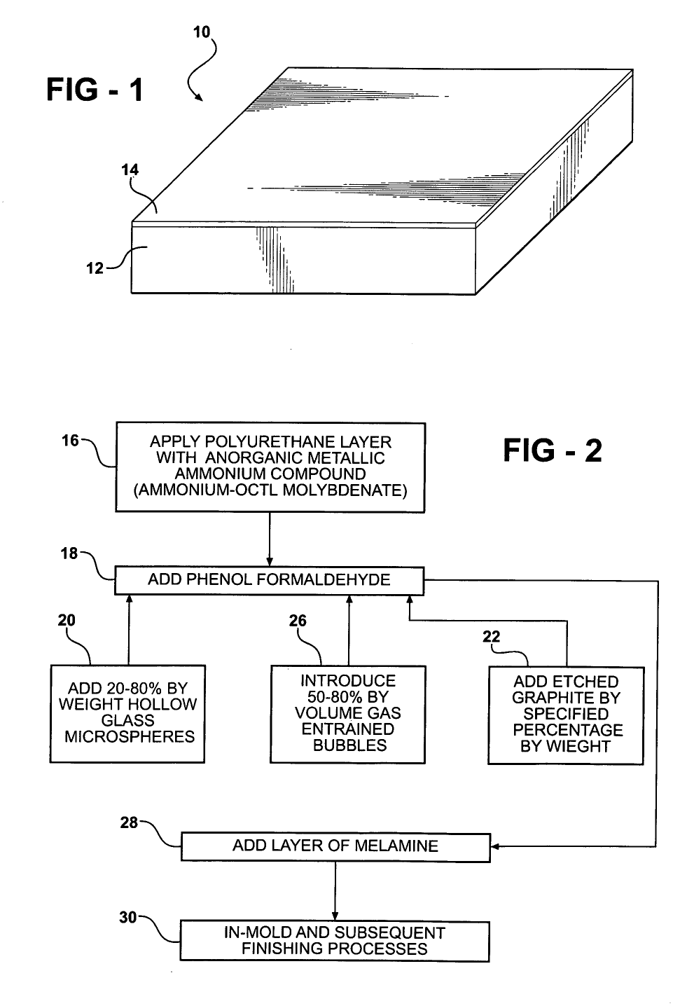

Referring now to FIG. 1, a flame and smoke-retardant structure is represented at 10 according to a preferred embodiment of the present invention. As previously stated, the structure, and associated method for producing, provides an article exhibiting superior fire, heat and smoke-resistant characteristics, and which satisfies known ASTM standards.

The panel-like structure 10 illustrates one possible arrangement of structure and which, in a preferred embodiment, is based upon a material known under the commercial name ULTRATEX®. The material is produced in an in-mold process and includes, in its basic form, a polyurethane layer, a phenol formaldehyde layer (illustrated in collective fashion at 12), and a surface coating of a water and chipping impervious layer 14, such as for example Melamine.

Referring now to the schematic illustration of FIG. 2, an explanation of the novel structure includes step 16, and which teaches the application (into a suitable mold exhibiting the overall shape and configuration of the end-desired product) of a polyurethane material incorporating a volume of an anorganic metallic stabilant. The stabilant further includes, in a preferred embodiment, an ammonium compound (NH3), the purpose for which is to stabilize the polyurethane layer without affecting its mechanical properties. In a preferred application, an ammonium-octyl molybdenate is provided as the stabilant.

At step 18, a phenol formaldehyde material is applied and which includes a volume of an inorganic particulate. In one variant, the inorganic particulate is provided by a volume of hollow glass microspheres, and such as which may be added in a range of 20-80% by weight relative to the weight of the phenol formaldehyde material.

At step 22, a volume of acid etched graphite particulates may be added, also by a specified percentage by weight, and relative to the phenol formaldehyde layer. The graphite particulate may be provided in combination with or in substitution of the hollow glass microspheres. A feature of the graphite particulate is its ability to expand, up to a factor by volume of 30×, and in response to the structure being exposed to heat in a determined range, such as for example at 300 to 600° F. The advantage derived from this expansion characteristic is to provide the article with an air buffer to further assist in heat insulation.

At step 26, a volume of air pockets may be formed, typically by gas entrainment, within the phenol formaldehyde material 18, and again as an additional or alternative step to the application of the hollow glass microspheres 20 and/or etched graphite particulate 22. The air pockets provide additional heat insulative properties and may be formed at a volume of 50% to 80% relative to that of the layer established by the phenol formaldehyde material.

The water-impervious coating is, in the preferred embodiment, Melamine which is commercially known to be of crystalline powder form and which, in a preferred embodiment, may be applied in an in-mold and subsequent finishing process, see step 30, along with the volumes of polyurethane and phenol formaldehyde material. It is also envisioned that other surface coating materials can be utilized according to the present invention.

A method of producing a flame-retardant structure is also disclosed and includes the steps of applying, into a mold, a polyurethane material including an anorganic metallic stabilant and applying a phenol formaldehyde material including an inorganic particulate. Additional steps include applying a water-impervious organic surface coating heat and pressure to cure and to compress said materials into a finished three-dimensional product.

Additional steps include applying an ammonium octyl molybdenate stabilant to the polyurethane material. A volume of hollowed spheres are applied to the phenol formaldehyde material and typically in a range of 20 to 80 percent, by weight, relative to the polyurethane material.

Additional steps include the step of forming a plurality of gas-entrained air pockets within the structure, and typically in a range of 50 to 80 percent volume relative the structure and/or applying a volume heat expandable and acid etched graphite particulates to the phenol formaldehyde material.

Other steps include applying a water-impervious coating further defining the step of applying, into the mold, a layer of a crystalline and non-toxic powder, the step of applying at least one of a sanding, trimming and finishing process to said flame-retardant structure.

Having described my invention, other and additional preferred embodiments will become apparent to those skilled in the art to which it pertains, and without deviating from the scope of the appended claims.

1. A flame-retardant structure, comprising:
a polyurethane material including an organometallic stabilant, said stabilant further comprising an ammonium octamolybdate;
a phenol formaldehyde material including an inorganic particulate; and
a water-impervious surface coating.

2. The flame-retardant structure as described in claim 1, said organometallic stabilant further comprising an ammonium compound.

3. (canceled)

4. The flame-retardant structure as described in claim 1, said inorganic particulate further comprising a volume of hollowed spheres.

5. The flame-retardant structure as described in claim 1, said inorganic particulate further comprising a range of 20 to 80 percent, by weight, relative to said polyurethane material.

6. The flame-retardant structure as described in claim 1, further comprising a plurality of gas-entrained air pockets established within said structure and in a range of 50 to 80 percent volume.

7. The flame-retardant structure according to claim 1, said inorganic particulate further comprising a volume of acid etched graphite particulates.

8. The flame-retardant structure according to claim 1, said water-impervious coating further comprising an organic chemical material.

9. A method of producing a flame-retardant structure, comprising the steps of:
applying, into a mold, a polyurethane material including an organometallic stabilant;
applying an ammonium octamolybdate stabilant to said polyurethane material;
applying a phenol formaldehyde material including an inorganic particulate;
applying a water-impervious organic surface coating; and
applying heat and pressure to cure and to compress said materials.

10. (canceled)

11. The method as described in claim 9, further comprising the step of applying a volume of hollowed spheres to said phenol formaldehyde material.

12. The method as described in claim 9, further comprising the step of applying said inorganic particulate in a range of 20 to 80 percent, by weight, relative to said polyurethane material.

13. The method as described in claim 9, further comprising the step of forming a plurality of gas-entrained air pockets within said structure and in a range of 50 to 80 percent volume relative said structure.

14. The method as described in claim 9, further comprising the step of applying a volume of acid etched graphite particulates to said phenol formaldehyde material.

15. The method as described in claim 9, said step of applying a water-impervious coating further comprising the step of applying, into the mold, a layer of a crystalline and non-toxic powder.

16. The method as described in claim 9, further comprising the step of applying at least one of a sanding, trimming and finishing process to said flame-retardant structure.

17. The method as described in claim 14, further comprising the step of expanding said graphite particulates upon heating above a specified temperature.
